(19) United States
(12) Patent Application Publication
(10) Pub. No.: US 2007/0196161 A1
(43) Pub. Date: Aug. 23, 2007

(54) Storage device with suspension elements

(76) Inventor: Alfred Langerak, Mijnsheerenland (NL)

Correspondence Address: HOFFMANN & BARON, LLP, 6900 JERICHO TURNPIKE, SYOSSET, NY, 11791, US

(21) Appl. No.: 10/587,555

(22) PCT Filed: Jan. 31, 2005
(86) PCT No.: PCT/NL05/00072

§ 371 Date: Apr. 12, 2007

(30) Foreign Application Priority Data
Jan. 30, 2004 (NL) 1025365

(51) Int. Cl. B42F 13/20

(52) U.S. Cl. 402/41

(57) ABSTRACT

The invention relates to a storage device (1) provided with a front cover (2) and a back cover (3), pivotally connected to each other and/or to a spine (4) such that by pivoting the covers, the storage device (1) can be brought from an opened condition to a closed condition and vice versa, while against one of the covers and/or the spine a binder, in particular a ring binder, is provided while adjacent two opposite ends a suspension element (12) is provided which is movable between a first condition in which the suspension elements (12) extend within the storage device (1) in closed condition and a second condition in which they extend outside the storage device (1) in closed condition such that the storage device (1) can be suspended by the suspension elements (12).

The invention relates to a storage device for, for instance, paper and the like.

For storing for instance paper, presentation sheets and such means, use is made of, for instance, suspension files, display jackets, document files and the like. As a rule, such storage devices are provided with a pin binder or a ring binder, comprising one or more rings which are divisible and can be held in a closed condition with the aid of spring elements. For placing sheets into the rings or removing sheets from the rings, these can be opened and closed counter to the spring elements. In general, such storage devices are indicated as ring binders, multo® ring binders and the like. These storage devices have as an advantage that they retain the sheets well but are difficult to store. They can only be laid down or put upright.

Furthermore, suspension files are known. As a rule, such files consist of a folded sheet of cardboard or plastic, while at two opposite, longitudinal edges of this sheet, a stiffening strip is provided. This stiffening strip extends at both sides of the sheet such that the file in closed condition can be suspended by these strips at two opposite rails of a cabinet or such suspension elements. In some suspension files, a two-hole binder element is provided on which sheets of paper can be fixed. These suspension files have as a drawback that they cannot stand upright and that, furthermore, they always have the projecting stiffening strips by which the files can be suspended. This renders the suspension file extra wide and difficult to carry along.

These known storage devices have the additional drawback that they are open to three sides and that consequently, the content is not optimally protected.

The object of the invention is to provide a storage device provided with a ring binder as described hereinabove, with which sheets and the like can be fixed in the storage device, which storage device has an increased ease of use with respect to the known devices.

A further object of the invention is to provided a storage device that can function as suspension file but with which, during transport, no elements by which the storage device can be suspended project outside the storage device.

The invention further contemplates providing a storage device which can be completely closed, both when it is used as suspension file and when it is used as conventional ring binder.

The invention further contemplates providing a storage device that can be easily carried along but can equally well be easily stored.

At least a number of these and comparable and further objects are achieved with a storage device according to the invention.

A storage device according to the invention comprises two covers pivotable relative to each other, preferably mutually connected by a spine. A binder is provided on one of the covers and/or on the spine. As a result, the storage device has, to some extent, the form of a suspension file, document file or ring binder album. On both sides of the binder, a suspension element is provided which can be slid outwards or pivoted between a first condition in which it is situated completely within the storage device with the storage device closed, and a second condition in which the suspension elements extend outside the storage device such that the storage device can be suspended by them in closed condition, comparable to a suspension file.

In this application, binder is at least understood to mean a binding mechanism provided with pins, rings or the like on which papers or the like can be pinned. Ring binder is at least understood to include a device provided with ring elements extending at a distance from each other, approximately parallel to each other, which ring elements can be opened and closed by means of an operating mechanism or manually, and on which ring elements in opened condition products such as sheets with perforations or such suitable openings can be provided or be taken therefrom, while the products cannot be placed on the ring elements or be taken from the ring elements if the ring elements are closed. Here, in particular, the ring elements are kept closed by spring means.

With a storage device according to the invention, preferably, ring binders are used with at least two ring elements extending in approximately parallel planes, and attached to a body with a longitudinal direction, while said planes extend approximately as normal planes at right angles to the longitudinal direction.

As, with a storage device according to the invention, suspension elements are provided which either can be moved entirely within the storage device such that they no longer project, or can extend outside the storage device such that the storage device can be suspended by them, the storage device can simply be carried along or stored away, without projecting parts, while the storage device can simply be suspended by the suspension elements, for instance in a filing cabinet or the like.

In this description, the terms “approximately” “substantially” and the like are understood to include that a small discrepancy with the value mentioned there is admissible, a small discrepancy being understood to at least include a discrepancy of 10% or less of the respective value. Therefore, at right angles is for instance understood to include at least an angle of 90° plus or minus 9°, for lines or planes which are approximately or substantially parallel and include a mutual angle of less than 10°.

Preferably, with a device according to the invention, the suspension elements are designed as a part of a ring binder, more in particular as a part of the or each operating mechanism for opening and closing the ring elements of the ring binder. As a result, a simple and functional construction is obtained.

Preferably, the suspension elements are then designed such that they are movable as operating handle between a first and a second position which define the first and second condition and in which the ring elements are closed while a third position is passed in which the ring elements are opened. Thus, it is ensured in a simple manner that the ring elements are always closed when the storage device is suspended by the suspension elements and when the storage device is stored and/or carried along with the suspension elements in the first condition.

In the third position, it is preferred that the suspension elements extend partly outside the storage device if it has been closed or is closed so that it is clear that the ring elements of the ring binder are open. It is then further preferred that at least one of the covers and/or the spine are provided with an upright longitudinal edge such that, in closed condition, a storage device is obtained with a closed off inner space in which the binder and the sheets provided thereon are confined. It is preferred that the storage device cannot be closed if the suspension elements are in the third condition, at least third position. Passage openings can be provided, preferably closable, through which the suspension elements can extend in the second condition.

The suspension elements can be pivotable about an axis, which axis can be situated, for instance, parallel to a longitudinal axis of the binder or include an angle therewith. Also, the suspension elements can be extendible.

Preferably, the suspension elements are designed such that when the storage device is suspended by them, the covers hang downwards, next to each other, while the center of gravity of the storage device is situated approximately straight below a line through the suspension elements, the covers extending approximately vertically, at least a center plane between these covers.

Further advantageous embodiments are described in the subclaims.

In clarification of the invention, embodiments thereof will be further elucidated with reference to the drawing. In the drawing:

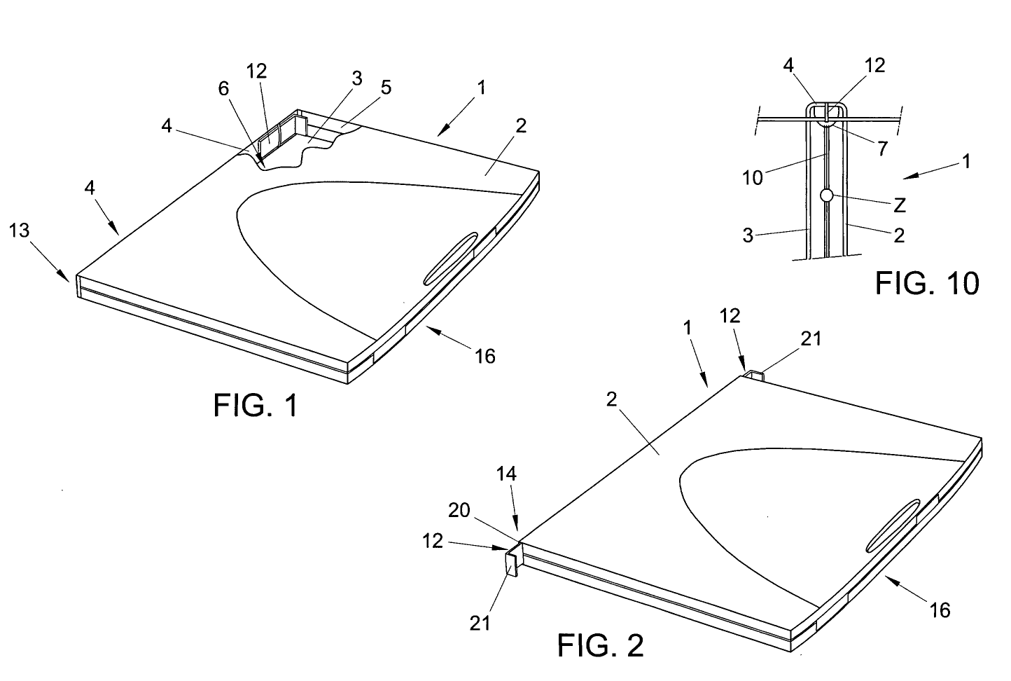

FIG. 1 shows, in partially cutaway, perspective view, a storage device according to the invention, with suspension elements in a first condition such that the suspension elements extend within the storage device;

FIG. 2 shows a storage device according to FIG. 1, with suspension elements in a second condition such that they project outside the storage device;

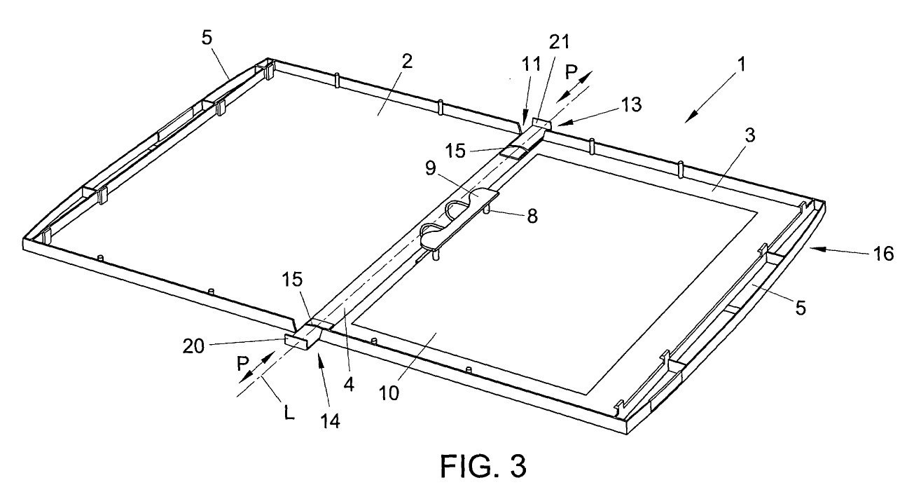

FIG. 3 shows a storage device according to FIGS. 1 and 2, in opened condition;

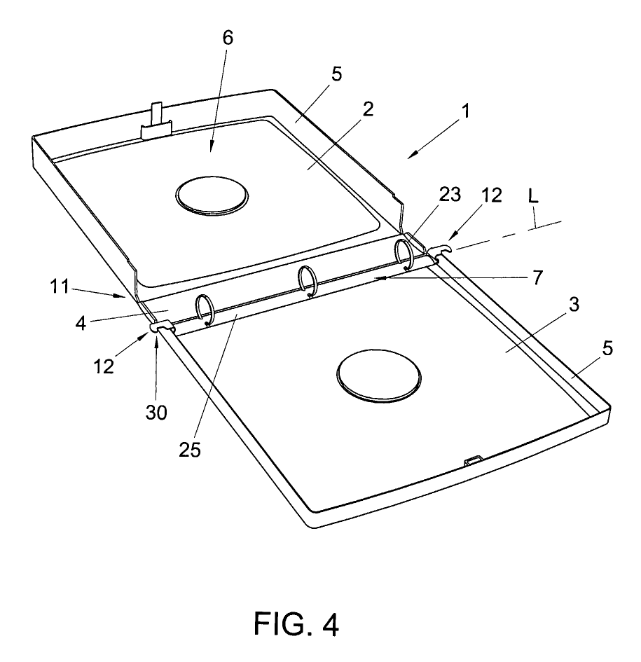

FIG. 4 shows, in opened condition, a storage device according to the invention, in a first alternative embodiment;

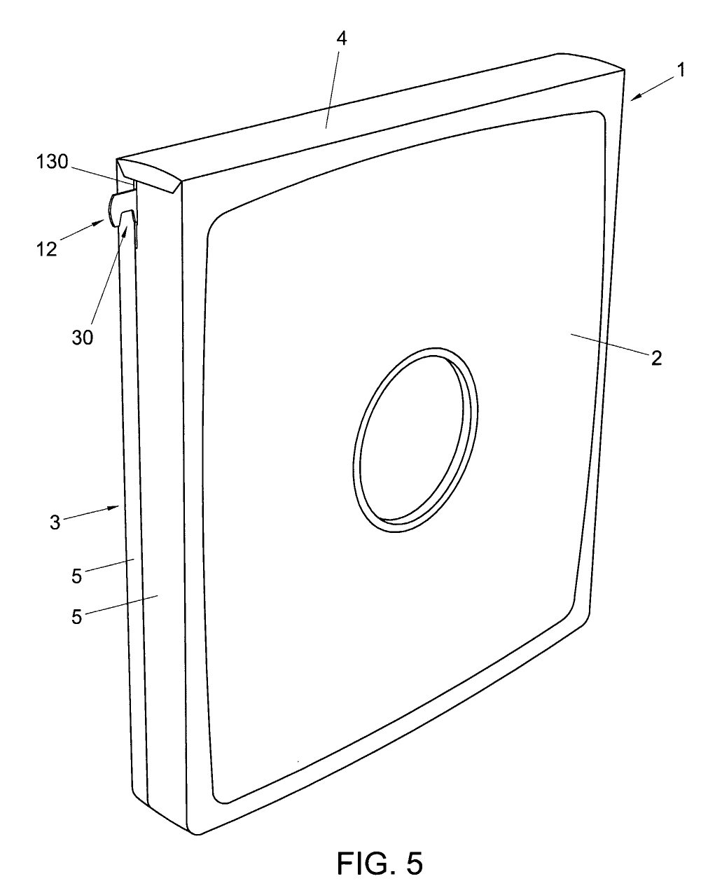

FIG. 5 shows, in closed condition, a storage device according to FIG. 4, with projecting suspension elements;

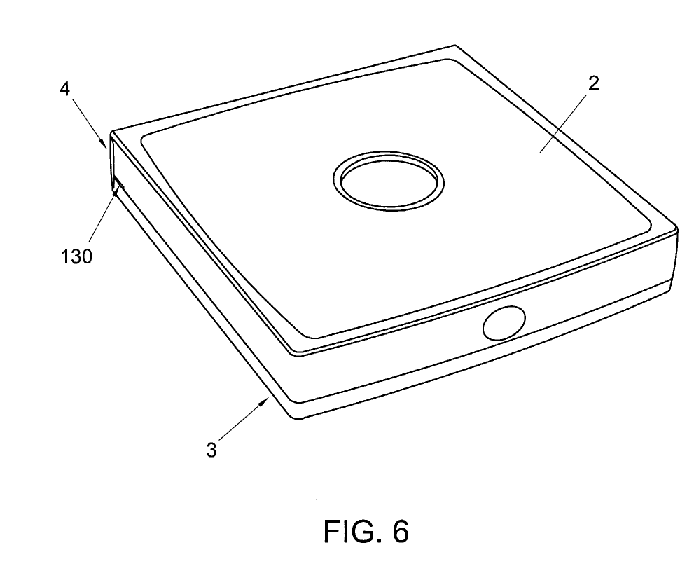

FIG. 6 shows in closed condition a storage device according to FIGS. 4 and 5, with retracted suspension elements;

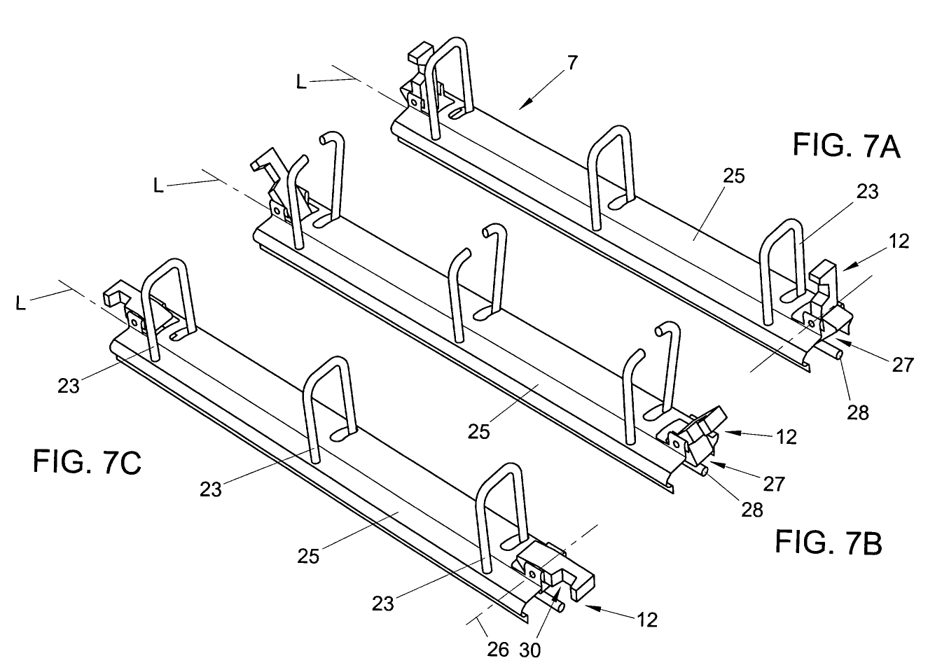

FIGS. 7A-C show a ring binder according to the invention, in three conditions;

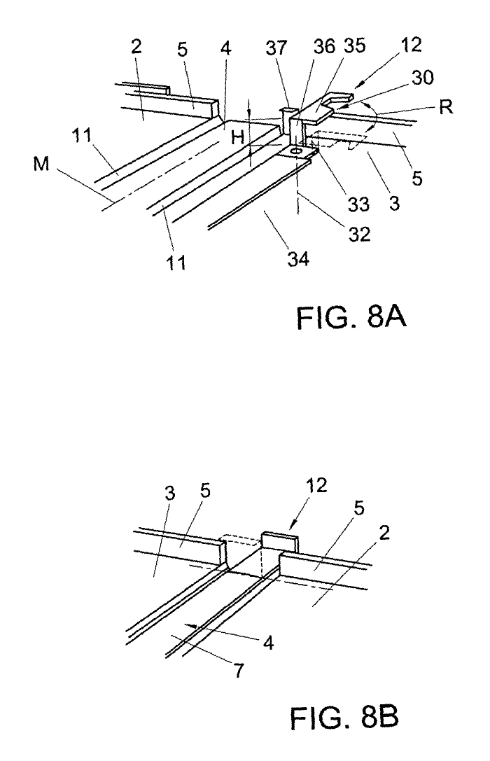

FIGS. 8A and B show two alternative embodiments of the suspension elements for a storage device according to the invention;

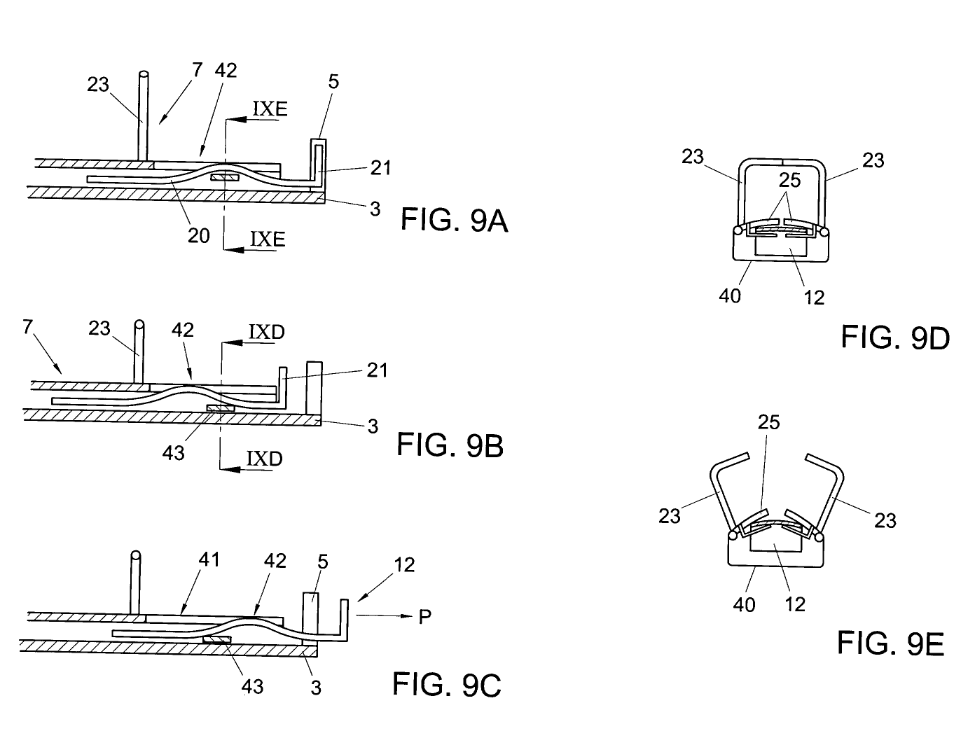

FIGS. 9A-E show a third alterative embodiment of a suspension element with ring binder according to the invention; and

FIG. 10 shows a storage device according to the invention, in side view, suspended by the suspension elements.

The embodiments shown in the drawings and described hereinafter are only given as examples and should not be construed as being limitative in any way. In this description, embodiments of binders are given, in particular ring binders and pin binders. However, naturally, all sorts of other binders known per se can be used in a storage device according to the invention. In the embodiments shown, sheets that have been fixed on or to the binders hang down from this binder if the storage device is suspended by the suspension elements. However, naturally, a binder can also be placed such that the longitudinal direction of the binder extends vertically or that several binders are provided, with longitudinal directions parallel to or at an angle relative to each other.

FIGS. 1-3 show a first embodiment of a storage device 1 according to the invention, comprising a front cover 2 and a back cover 3, pivotally connected to an interposed spine 4. The covers 2, 3 and the spine 4 are provided with an upright longitudinal edge 5 such that in the closed condition as shown in FIGS. 1 and 2, a substantially closed inner space 6 is obtained. As appears from FIG. 3, in the inner space 6 a binder 7 is included, for instance provided with two pins 8 on which a closing strip 9 can be fixed. Papers 10 can be pinned on the pins 9 with a suitable perforation.

A storage device 1 according to the invention can be manufactured from any desired material but is preferably manufactured from plastic, in particular by injection molding while the binder 7 can be formed simultaneously or be mounted later.

In the embodiment shown in FIGS. 1-3, the binder 7 is attached on the back cover 3 adjacent a hinge 11, at least adjacent an edge of the back cover 3 facing the spine 4. However, the binder 7 can also be placed on the spine or on the front cover and, optionally, several binders can be provided, next to each other or on different covers and/or the spine.

In the embodiment shown in FIGS. 1-3, two suspension elements 12 are provided on the spine, which are slideable in the longitudinal direction L of the spine, in opposite directions P. As a result, the suspension elements 12 are slideable between a first condition 13 as shown in FIG. 1 and in FIG. 3 on the top right hand side, wherein the suspension element is situated on the spine and extends completely within the storage device 1, and a second condition 14 as shown in FIG. 2 and in FIG. 3 on the bottom left hand side, wherein the suspension element extends partly outside the spine, outside the storage device. Each suspension element 12 is slideably confined on the back by a strip 15 or different confinement. Each suspension element 12 is for instance somewhat L-shaped, a long arm 20 extending along the spine 4 and a short arm 21 extending approximately parallel to the longitudinal edge 5 in the direction of the opposite edge 16 of the covers 2, 3. When the two suspension elements 12 have been brought into the second condition, the storage device can be suspended by them in, for instance, a filing cabinet or such device with two suspension rails as schematically shown in FIG. 10. The center of gravity Z of the storage device 1 with sheets will extend straight below a line through the suspension elements, while the covers 2, 3 extend approximately vertically next to each other, at least in the closed condition. With the suspension elements in the first condition, the storage device can easily be carried along because then, the suspension elements do not protrude.

In the longitudinal edge of the covers 2, 3, on both sides adjacent the spine 4, an opening 18 is provided through which the suspension elements 12 can project in the second condition. The first condition for that matter can also be defined such that the short arms 21 lie in a cavity in, or abut against the outside of the longitudinal wall 5 such that the suspension elements cannot become stuck behind other objects when the storage device is carried along. This too should be understood to be included by within the storage device.

FIGS. 4-6 show an alternative embodiment of a storage device according to the invention, again provided with a front cover 2, a back cover 3 and an interposed spine 4 to which the covers are pivotally connected. Again, each cover 2, 3 is provided with an upright longitudinal edge 5 so that a closed inner space 6 can be obtained. With this embodiment, a binder 7 in the form of a ring binder is provided. Ring binders are sufficiently known per se, in various embodiments with two or more rings 23 which are divisible so that sheets and the like can be fixed thereon. One embodiment of a ring binder 7 according to the invention is shown in FIGS. 7A-C. This is substantially distinguished from known ring binders by the operating mechanism for opening and closing the rings 23. With a ring binder 7 according to the invention, to this end, suspension elements 12 are used as operating arms.

The ring binder 7 comprises a curved plate part 25 extending in a longitudinal direction. A number of divisible rings 23 (three in the exemplary embodiment) are fixed on the plate part 25. The plate part 25 is biased towards a flat condition, so that the rings are held in a closed condition as shown in FIGS. 7A and 7C. In order to open the rings 23, the plate part 25 is to be curved further, counter to the spring action, to the position shown in FIG. 7B. Naturally, ring binders can be designed in various manners. For a ring binder according to the invention it is of importance that on one end, and preferably on both ends, a suspension element 12 is provided for pivotal movement about an axis 26. Each pivot arm can be brought in a first position (FIG. 7A), a second position (FIG. 7C) and a third position (FIG. 7B) through pivotal movement about the axis 26. With the suspension elements in the first or third position, the rings 23 are closed through the spring action.

In the first position (FIG. 7A) each suspension element 12 is approximately straight up, that is to say, approximately at right angles to the longitudinal direction L of the ring binder, approximately parallel to the planes defined by the rings 23. If the storage device 1 is closed with the suspension elements in the first position (FIG. 6), the suspension elements 12 lie entirely within the inner space 6. If the suspension elements are in the third position (FIG. 7C) they extend approximately in the longitudinal direction L of the ring binder 7, so that, with the storage device 1 in closed position (FIG. 5), the suspension elements 12 extend partially outside the inner space 6 of the storage device and the storage device can be suspended by them in an earlier described manner.

With the suspension elements 12 in the third position (FIG. 7B), the curvature of the plate part 25 is increased in that with a suitable section 27, the suspension elements 12 push against a pin 28 or other surface located below the plate part 25. The rings are therefore opened.

In FIG. 4, an opened storage device 1 is shown with the suspension elements 12 in the second position. From this position, the storage device can be closed with the suspension elements partly outside the inner space, so that the storage device can be suspended by them. If the suspension elements are in the third position (FIG. 7B) the storage device cannot be closed as the longitudinal edges 5 will then run into the suspension elements 12. If the suspension elements are in the first position the storage device can be closed again. Thus, undesired opening of the ring binder 7 is prevented.

The suspension elements 12 in the embodiment shown in FIG. 7 are provided with a recess 30 for allowing simpler and better suspension.

FIGS. 8A and B show two alternative embodiments of suspension elements 12 according to the invention, with a part of an opened storage device 1. In FIG. 8, the suspension element 12 is pivotable about an axis 32 extending approximately at right angles to the face 34 on which the suspension element has been provided. The suspension element has a first face 33 resting on the face 34, a third face 35 extending approximately parallel to the first face 34 and a second face 36 connecting the first and the third face and extending, for instance, approximately at right angles to the two faces 33, 35. Preferably, the second face 36 has a height H such that the third face 35 can be pivoted over the longitudinal edge 5 in the direction R and runs into a projection 37 on the longitudinal edge. With the storage device 1 closed, the third face 35 will then project approximately at the height of the centerline M of the spine so that the storage device can be suspended by it in a stable and straight manner.

In FIG. 8B, a suspension element 12 is shown comparable to that as shown in FIG. 7, positioned, however, on the spine 4.

If suspension elements as shown in FIGS. 8A and B are used with a ring binder, again, a suitable section can be provided (not shown) with which the rings of the ring binder can be opened and closed, while, once more, the first position (shown in interrupted lines in FIGS. 8A and 8B) and the second position (shown in full lines in FIGS. 8A and 8B) define the closed condition of the rings 23 and an intermediate third position defines the closed condition.

FIGS. 9A-E show an alternative embodiment of a binder 7 with suspension elements 12 for operation thereof. In this embodiment, two plate parts 25 are pivotally connected by a spring 40. In the longitudinal edge facing the other plate part 25, adjacent each end thereof, each plate part 25 is provided with a recess 41. A suspension element 12 is provided below the plate parts, one at each end, comparable to that as shown and described in FIG. 3. Each suspension element has, in a middle area, a curvature 42 extending over a lip 43 provided at the underside of each plate part 25.

In FIG. 9A, a suspension element 12 is shown in a first position. The suspension element is slid inwards maximally, into the inner space 6. Here, the underside of the curvature 42 is slid over the lips 43 such that it is pressed downwards in the direction of the cover 2, 3 or the spine 4 on which the ring binder 7 has been fixed. The lips 43 pull the plate parts 25 downwards, thereby closing the rings 23, as shown in FIG. 9D in cross-sectional view.

The suspension element can be slid out in the direction P from the first position shown in FIG. 9A to the second position shown in FIG. 9C, while the lips are pressed down too and hence the rings are closed. Between the first and the second position, the suspension element passes the third position as shown in FIGS. 9B and 9E. The lips 43 then find the space below the curvature 42 as a result of which the spring action of the spring can slightly pivot the plate parts 25 so that the rings 23 are opened. Incidentally, the spring could also be omitted if the top of the curvature in the third position were to run into, for instance, a cross element in the recess, thereby forcibly pivoting the plate parts. In the third position, a short arm 21 of the suspension element 12 extends at the height of the longitudinal edge 5, so that the storage device cannot be closed with opened rings.

In all embodiments shown, passage openings in the longitudinal walls can be provided through which the suspension elements can extend.

The invention is not limited in any manner to the embodiments shown. Many variations thereon are possible within the framework of the invention.

For instance, other (ring) binders can be used, with the suspension elements preferably functioning as operating means. The passage openings in the longitudinal walls for allowing the suspension elements through can optionally be provided with closures such as sliding means or flapping means so that a still better closed off inner space can be provided. Several binders can be provided while, furthermore, the longitudinal edges can also be completely or partly omitted or be provided on one side. The binders can also be attached on a different location or be detachably provided. The pivot for the suspension elements can be provided at any suitable angle.

These and many comparable variations are understood to fall within the framework of the invention as outlined by the claims.

1. A storage device provided with a front cover and a back cover, pivotally connected to each other and/or to a spine such that by pivoting the covers, the storage device can be brought from an opened position to a closed position and vice versa, wherein against one of the covers and/or the spine a binder, in particular a ring binder, is provided while adjacent two opposite ends a suspension element is provided which is movable between a first condition in which the suspension elements extend within the storage device in closed condition and a second condition, in which they extend outside the storage device in closed condition such that the storage device can be suspended by the suspension elements.

2. A storage device according to claim 1, wherein the binder is a ring binder which comprises at least two rings for retaining sheets, which rings are movable between an opened and a closed condition with the aid of an operating mechanism.

3. A storage device according to claim 2, wherein the suspension elements form part of the operating mechanism.

4. A storage device according to claim 3, wherein the suspension elements are pivotable or slideable relative to at least the rings of the ring binder, between at least three positions, while:
in a first position, the suspension elements are in the first condition and the rings are in the closed condition;
in a second position, the suspension elements are in the second condition and the rings are in the closed condition; and
in a third position, the suspension elements are in a third condition preferably between the first and the second condition, with the rings in the opened condition.

5. A storage device according to claim 4, wherein the suspension elements in the third position extend at least partly outside the storage device in closed condition.

6. A storage device according to claim 1, wherein the binder has a longitudinal direction while the suspension elements are slideable in the longitudinal direction.

7. A storage device according to claim 1, wherein the binder has a longitudinal direction, the suspension elements being pivotal about a pivot extending approximately at right angles to said longitudinal direction and including an angle with the cover and/or the spine to which the binder has been attached.

8. A storage device according to claim 1, wherein the ring binder has a longitudinal direction, while the suspension elements are pivotal about a pivot which extends approximately at right angles to said longitudinal direction, approximately parallel to the cover and/or the spine to which the binder has been attached.

9. A storage device according to claim 1, wherein one or each cover and/or the spine comprise an upright edge such that in closed condition, the or each upright edge, the covers and the spine define a substantially closed inner space of the storage device, while passage openings are provided for the suspension elements.

10. A storage device according to claim 9, wherein the passage openings are closable.

11. A storage device according to claim 1, wherein the suspension elements are placed and/or formed such that with the suspension elements in the second condition, the storage device can be suspended by the suspension elements and the covers extend next to each other with the center of gravity straight below a connecting line through the suspension elements.
